(19) United States
(12) Patent Application Publication
(10) Pub. No.: US 2005/0231849 A1
(43) Pub. Date: Oct. 20, 2005

(54) Graphical user interface for hard disk drive management in a data storage system

(76) Inventors: Viresh Rustagi, Sunnyvale, CA (US); Christopher S. Wilson, Sunnyvale, CA (US); Kenneth Ma, Cupertino, CA (US)

Correspondence Address: MCANDREWS HELD & MALLOY, LTD, 500 WEST MADISON STREET, SUITE 3400, CHICAGO, IL, 60661, US

(21) Appl. No.: 11/101,734

(22) Filed: Apr. 8, 2005

Related U.S. Application Data
(60) Provisional application No. 60/562,910, filed on Apr. 15, 2004.

(51) Int. Cl. G11B 5/012

(52) U.S. Cl. 360/97.01

(57) ABSTRACT

Herein described is at least a method and a system of providing a graphical user interface which may be used in the management of one or more data storage drives or hard disk drives. In a representative embodiment, a method of modifying the size of a data pool comprises using a point and click device on a graphical user interface. In a representative embodiment, a system for resizing the storage capacity allocated for a data pool comprises a memory, software instructions resident in the memory, and a processor capable of executing the software instructions. A user interface, capable of resizing the storage capacity of the data pool, is generated when executing the software instructions.

### CROSS-REFERENCE TO RELATED APPLICATIONS/INCORPORATION BY REFERENCE

This application makes reference to and claims priority from U.S. Provisional Patent Application Ser. No. 60/562,910, entitled “GRAPHICAL USER INTERFACE FOR HARD DISK DRIVE MANAGEMENT IN A DATA STORAGE SYSTEM”, filed on Apr. 15, 2004, the complete subject matter of which is incorporated herein by reference in its entirety.

This application is related to and/or makes reference to:
U.S. application Ser. No. 11/049,905 (Attorney Docket No. 15673US02) filed Feb. 3, 2005;
U.S. application Ser. No. ______ (Attorney Docket No. 15675US03) filed Mar. 22, 2005;
U.S. application Ser. No. ______ (Attorney Docket No. 15678US02) filed Apr. 8, 2005;
U.S. application Ser. No. ______ (Attorney Docket No. US03) filed Mar. 30, 2005;
U.S. application Ser. No. 11/049,772 (Attorney Docket No. 15682US02) filed Feb. 3, 2005;
U.S. application Ser. No. 11/049,798 (Attorney Docket No. 15683US02) filed Feb. 3, 2005;
U.S. application Ser. No. ______ (Attorney Docket No. 15684US02) filed Mar. 22, 2005; and
U.S. application Ser. No. 11/049,768 (Attorney Docket No. 15685US02) filed Feb. 3, 2005.

The above stated applications are hereby incorporated herein by reference in their entireties.

### FEDERALLY SPONSORED RESEARCH OR DEVELOPMENT

[Not Applicable]

[MICROFICHE/COPYRIGHT REFERENCE]

[Not Applicable]

### BACKGROUND OF THE INVENTION

As the data storage requirements for a user changes, a user may wish to adjust the size of one or more data storage units or data pools provided by one or more data storage drives. Unfortunately, making such changes may be an arduous task. The user may need to load and execute one or more software programs in order to resize the one or more data pools which span the one or more data storage drives. This task may involve a number of tedious and complex steps which may be difficult and time consuming. For example, the user may need to determine the available storage capacities provided by the one or more data storage drives. Further, the user may have to analyze one or more parameters of each of the one or more data storage drives before executing the one or more software programs.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the invention incorporate at least a method and a system of providing a graphical user interface used in the management of one or more data storage drives or hard disk drives. The graphical user interface may be used in allocating storage capacity provided by each of the one or more data storage drives. The storage capacity allocated using each of the one or more data storage drives may be used in forming one or more data pools. The aforementioned aspects are substantially shown and described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 illustrates a block diagram of a typical system incorporating the use of a networked attached storage device (NAS) in accordance with an embodiment of the invention.

FIG. 2 is a block diagram of a network attached storage device (NAS) in accordance with an embodiment of the invention.

FIG. 3 is a block diagram of a NAS chip (NASoC) in accordance with an embodiment of the invention.

FIGS. 4A and 4B provide operational flow diagrams illustrating the generation of one or more graphical user interfaces (GUIs) that provides hard disk drive management of the hard disk drives contained within the NAS, in accordance with an embodiment of the invention.

FIG. 5 illustrates a screen shot of Windows Explorer illustrating the directory contents of a NAS having an exemplary default name, Viresh-NAS; the screen shot occurs after Viresh-NAS is selected from the Workgroup directory, in accordance with an embodiment of the invention.

FIG. 6 illustrates a Windows Explorer screen shot of a directory that contains a configuration file, in accordance with an embodiment of the invention.

FIG. 7 illustrates a Netscape screen shot indicating that the configuration file is processing the command, in accordance with an embodiment of the invention.

FIG. 8 illustrates a Netscape screen shot of an exemplary graphical user interface that allows a user to input one or more administrative parameters, in accordance with an embodiment of the invention.

FIG. 9 displays a graphical user interface (GUI) used for displaying and configuring a data pool in accordance with an embodiment of the invention.

FIG. 10 illustrates a screen shot of a browser, such as Windows Explorer or Netscape, that provides a graphical user interface in which a user may point, click, and drag one or more displayed objects or visual indicators, in order to vary one or more values associated with the visual indicators, in accordance with an embodiment of the invention.

FIG. 11 illustrates a screen shot of a browser that provides an exemplary disk management user interface that allows a user to create, delete, or rename one or more data pools of the data storage device or NAS, in accordance with an embodiment of the invention.

FIG. 12 illustrates a graphical user interface in which a user may re-partition or resize one or more hard disk drives by dragging a selector or adjusting one or more controls within the graphical user interface, in accordance with an embodiment of the invention.

### DETAILED DESCRIPTION OF THE INVENTION

Aspects of the invention incorporate a method and system of providing a graphical user interface (GUI) that is used in the management of one or more data storage drives. Aspects of the invention provide a system and method that facilitates the automated pooling, mirroring, and striping of storage capacity provided by the one or more data storage drives. The one or more data storage drives are collectively incorporated into a data storage device that is communicatively coupled to one or more data processing devices. The data storage device and the one or more data processing devices may comprise a network. The one or more data processing devices may utilize the data storage device as a centralized storage facility. In a representative embodiment, the data storage device is referred to as a network attached storage device (NAS).

As described herein, a data storage device may comprise one or more data storage drives, such as hard disk drives, or any other type of drive. The data storage device may comprise a combination of different types of data storage drives. A data storage drive may comprise any type of media capable of storing data. Hereinafter, the term “hard disk drive” alternatively may refer to a data storage drive or any drive or component comprising a media used to store data. In a representative embodiment, one or more data storage drives or hard disk drives may be used within a data storage device. In a representative embodiment, the data storage device provides quick and easy replacement of the one or more data storage drives or hard disk drives. The capacity of the data storage device may be increased by replacing one or more data storage drives with one or more data storage drives of larger storage capacity. In another representative embodiment, the storage capacity of the data storage device is capable of being increased by adding one or more data storage drives or hard disk drives to the data storage device.

In a representative embodiment, the graphical user interface (GUI) allows a user to effectuate changes or modifications of one or more variables or parameters related to the allocation and management of one or more hard disk drives. In a representative embodiment, the changes are made by pointing, clicking, and/or dragging one or more visual identifiers displayed by the GUI, by way of a point and click device. The pointing, clicking, and dragging, may be performed by a mouse, for example. The mouse may be used to increase or decrease the one or more parameters associated with the one or more visual identifiers displayed by the GUI. In a representative embodiment, the parameters that are modified may comprise hard disk drive space associated with one or more levels of RAID, unused hard disk drive space in a data pool, JBOD space, and the like. In a representative embodiment, modification of the one or more visual identifiers displayed by the GUI adjusts or resizes the one or more parameters. In a representative embodiment, the GUI allows the user to input quantities associated with the one or more parameters into one or more fields. The GUI may provide a “pull-down” field in which a user may select one of several different selections associated with the one or more parameters. The GUI may allow a user to depress one or more buttons in order to effectuate the creation of data pools, the deletion of data pools, and the renaming of existing data pools. In a representative embodiment, the graphical user interface allows the user to re-partition one or more hard disk drives. The re-partitioning may involve the adjustment of the one or more hard disk drive's used space, free space, or unallocated disk space. The one or more hard disk drives may be used to form one or more data pools.

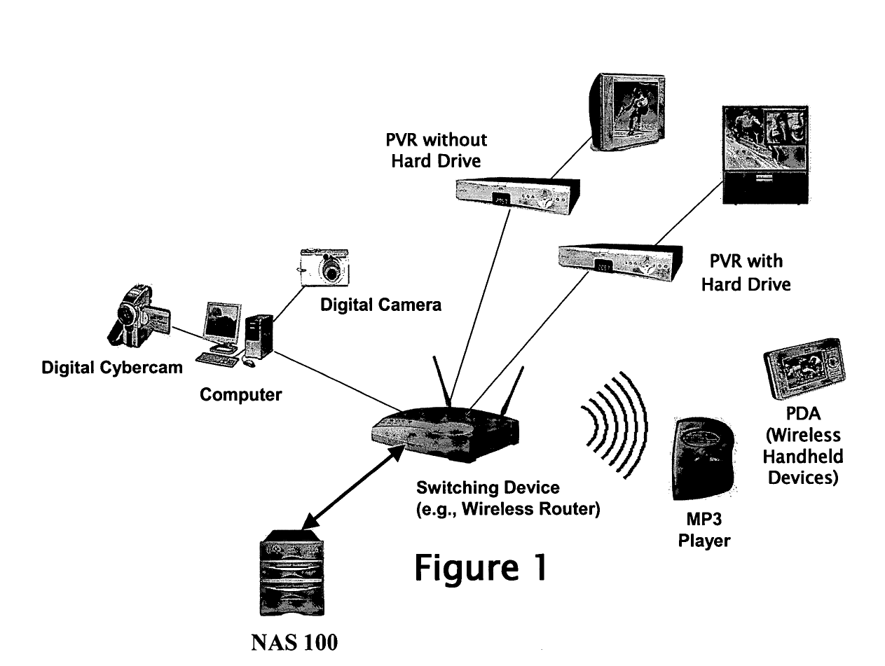

FIG. 1 illustrates a block diagram of a typical system incorporating the use of a NAS 100 in accordance with an embodiment of the invention. The NAS 100 provides data storage for one or more data processing devices. As illustrated, an exemplary switching device provides connectivity of the NAS 100 to the one or more data processing devices. The switching device is capable of providing connectivity using wireless or wireline communications. For example, a wireless router may utilize any one of the following wireless or wireline data communications protocols: 10/100 Ethernet, gigabit Ethernet, 802.11x, Bluetooth, and the like. The one or more data processing devices comprises devices such as a digital cybercam, digital camera, MP3 player, PDA, and one or more personal video recorders (PVRs). As illustrated, the PVR may be equipped with or without a hard disk drive. In a representative embodiment, the PVR may be referred to as a set-top-box (STB) that incorporates personal video recorder capabilities. In a representative embodiment, the PVR may be referred to as a PVR-STB. The PVRs illustrated, are connected to a television or a monitor capable of playing multimedia content to a home user. Use of the NAS 100 provides a centralized storage device for multimedia content received by the one or more PVRs. As a consequence of storing content in a NAS 100, PVRs lacking a storage facility, such as a hard disk drive, may store any data it receives into the NAS 100. Further, any data stored by other data processing devices, including PVRs, may be easily accessed and viewed by any of the one or more data processing devices. For example, a PVR without hard drive may access multimedia content originally stored into the NAS 100 by a PVR with hard drive, and vice-versa. As a result, the NAS 100 facilitates sharing of data among the one or more data processing devices. Since it provides a remote storage mechanism, the NAS 100 may be considered a “virtual storage device” by the one or more data processing devices. The NAS 100 is configured such that its storage capacity may be easily expanded. In a representative embodiment, the NAS 100 may accept additional hard disk drives. As such, the NAS 100 provides an easily scalable and flexible storage mechanism that accommodates for future data storage growth. In addition, the NAS 100 is capable of providing data mirroring and data striping capabilities.

When the NAS is first introduced to the exemplary switching device shown in FIG. 1, one or more of its parameters may be setup as part of an initialization process. In a representative embodiment, the parameters setup during the initialization process comprises the NAS time, date, and time zone. The NAS, for example, may utilize the computer illustrated in FIG. 1 as a reference source in setting up its time, date, and time zone. It is contemplated that the NAS may utilize any one of the other data processing devices (e.g., digital cybercam, digital camera, PVR without hard drive, PVR with hard drive, MP3 player, or PDA) shown in FIG. 1 as a reference source in the setup process.

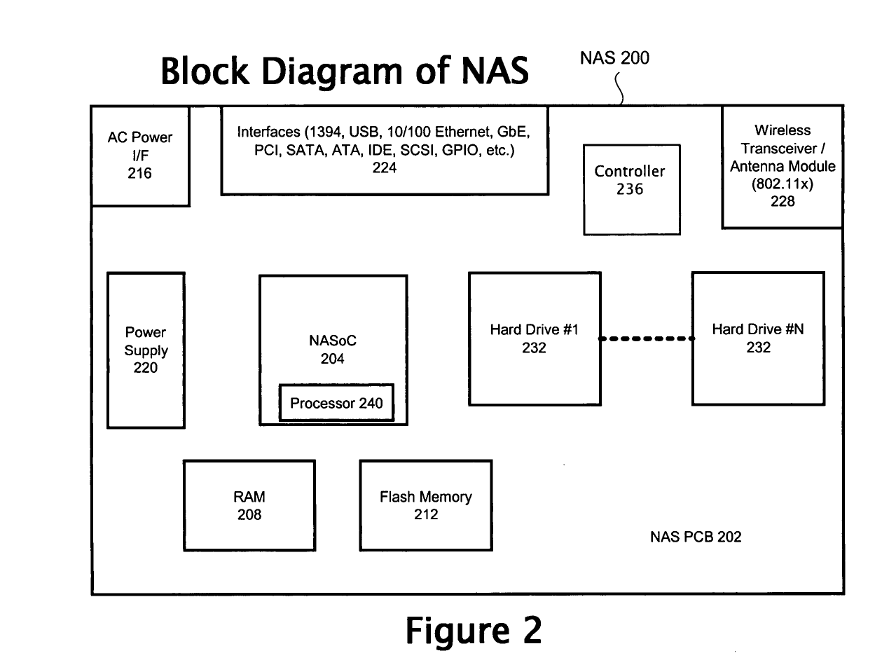

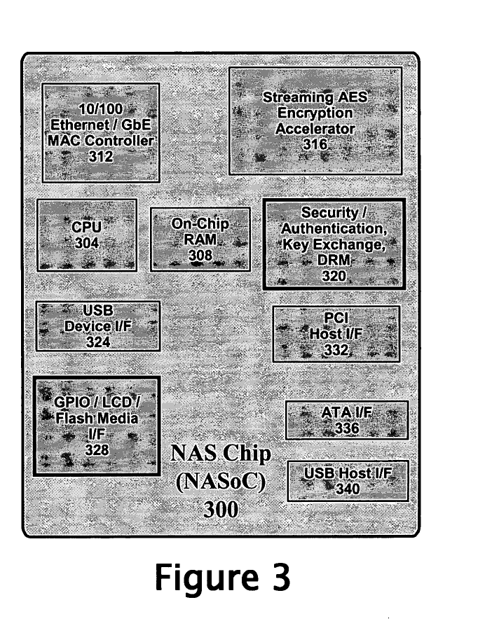

In a representative embodiment, the NAS setup process occurs after the NAS is physically connected to a network and recognized by an operating system such as a Microsoft Windows operating system. The following FIGS. 2 and 3 illustrate an embodiment of a NAS' system architecture.

FIG. 2 is a block diagram of a network attached storage device (NAS) 200 in accordance with an embodiment of the invention. The NAS 200 comprises a printed circuit board (NAS PCB) 202 containing one or more components. The one or more components are electrically connected by way of the printed circuit board (PCB) 202. The one or more components comprises a NAS chip (NASoC) 204, a random access memory 208, a flash memory 212, an AC power interface 216, a power supply 220, a block of interfaces 224, a wireless transceiver/antenna module 228, one or more hard disk drives 232, and a controller 236. The interface block 224 may comprise one or more of the following interfaces: IEEE 1394, USB, 10/100 Ethernet, gigabit Ethernet, PCI, SATA, ATA, IDE, SCSI, GPIO, etc. The wireless transceiver/antenna module 228 may comprise an attachable module or mini-PCI card that may be optionally connected or attached to the NAS' printed circuit board 202. The one or more hard disk drives 232 may comprise any number of hard drives depending on the design of the NAS 200. The printed circuit board 202 may be configured to accommodate an appropriate number of hard disk drives. The number of hard drives utilized may depend on the type of mirroring or data striping (i.e., RAID) provided by the NAS 200. In a representative embodiment, the controller 236 provides control for any one of several devices (such as hard disk drives) connected to the NASoC 204. The NASoC 204 may comprise an integrated circuit chip incorporating a processor or central processing unit (CPU) 240.

FIG. 3 is a block diagram of a NAS chip (NASoC) 300 in accordance with an embodiment of the invention. The NASoC 300 is an integrated circuit mounted on the previously described NAS PCB. The NASoC 300 provides one or more functions that allow the NAS to properly operate. The NASoC 300 comprises a central processing unit (CPU) 304, an on-chip random access memory 308, a Ethernet/MAC controller 312, an encryption accelerator 316, a security/authentication, key exchange, DRM chip 320, and a number of interfaces 324, 328, 332, 336, 340. The interfaces 324, 328, 332, 336, 340 may comprise, for example, the following type of interfaces: USB Device I/F 324, a PCI Host I/F 332, a GPIO/LCD/Flash Media I/F 328, an ATA I/F 336, and a USB Host I/F 340. The NAS chip 300 may communicate and/or connect to the one or more components described in reference to FIG. 2.

Referring to FIG. 2, the NAS 200 may incorporate varying numbers of hard disk drives depending on its storage and RAID (mirroring and/or striping) requirements. The NAS 200 chassis may be configured to incorporate 1, 2, 4, or more hard disk drives depending on type of use. For example, the NAS 200 may utilize 4 hard disk drives for implementing RAID 0+1 (both data mirroring and data striping), suitable for use in a small office/business environment. On the other hand, the NAS 200 may utilize only 1 or 2 hard disk drives in a home (or household) environment since the storage capacity utilized is typically less than that utilized in an office or business environment. Similarly, memory components utilized in the NAS 200 may be varied depending on type of use. As the data storage requirements increase and as the frequency of data storage related requests increase, the performance of the NAS 200 may be improved to meet its operational needs, by way of increasing memory size of the NAS 200. For example, DRAM memory capacities may be increased in order to improve the processing performance of the NAS 200.

In a representative embodiment, the processor 240 within the NASoC (204 or 300) executes software or firmware residing within the RAM 208 and/or flash memory 212 when the NAS 200 is booted up or powered up. In a representative embodiment, execution of the software generates the hard disk drive management user interface previously described. In a representative embodiment, execution of the software causes the http server to serve pages at a user's workstation (e.g., client workstation) facilitating the display of the desired hard disk drive management user interface. In a representative embodiment, the software that is executed by the processor 240 comprises a configuration file that is accessed and recognized by an operating system, such as a Microsoft Windows operating system, such that it may be viewed and run by file organizing application such as an exemplary Microsoft Windows Explorer application. In a representative embodiment, the configuration file is accessible before a user completes an initialization procedure on the NAS 200. The configuration file may be available even when there are no hard disks present within the NAS 200. The initialization process may involve creating one or more authentication passwords that are used in the future for accessing the configuration file. The Microsoft Windows operating system may comprise Windows XP, 2000, ME, 98, Pocket PC, or the like. When the configuration file is executed, by clicking on its filename as displayed by the Windows Explorer application, a user interface is displayed to a user's data processing device. Thereafter, a user may provide one or more inputs to initialize or configure the NAS 200. The inputs may comprise the following: a name for the NAS 200, an administration username, an administration password, one or more alternate security actuators, time, time zone, network time server internet protocol addresses, drive pool names, RAID type indicators, drive pool share names, and share access passwords. The drive pool names, RAID type indicators, drive pool share names, and share access passwords are exemplary parameters used in the disk drive management of the hard drives within the NAS 200. A share corresponds to one or more users who have the capability of writing to and reading from a particular pool. If there is more than one share for a pool, the disk space occupied by each share is cumulatively applied against the total space provided by the pool. In a representative embodiment, the previously mentioned disk drive management parameters are stored in the RAM 208 or flash memory 212, or one or more disk headers of one or more hard disk drives 232 of the NAS 200, as previously referenced in FIG. 2. The flash memory may comprise a non-volatile random access memory (NVRAM).

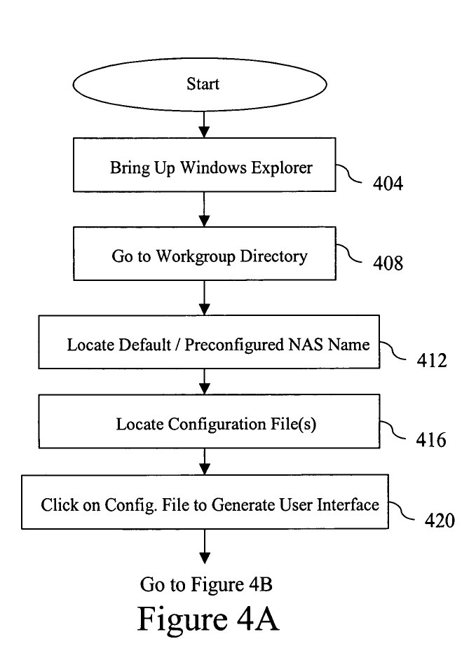

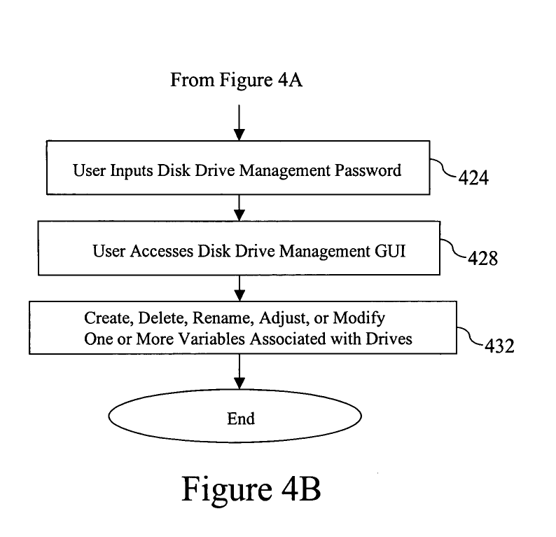

FIGS. 4A and 4B provide operational flow diagrams illustrating the generation of one or more graphical user interfaces (GUIs) that provides hard disk drive management of the hard disk drives contained within the data storage device or NAS, in accordance with an embodiment of the invention. At step 404, a user executes a file organizing application, such as the Microsoft Windows Explorer application, using a data processing device (e.g., his computer) in order to view one or more directories and their associated files. At step 408, the Workgroup or MSHOME directory (typically found in Windows Explorer) is accessed by the user, by “clicking” on this directory in the exemplary Windows Explorer user interface. In a representative embodiment, the Microsoft Windows operating system provides a mechanism that identifies and displays any data processing devices that employ such configuration files. Each of the data processing devices containing the configuration file is displayed to the user using Windows Explorer, for example. The data processing devices are identified by one or more default names configured within the data processing device's software or firmware. At step 412, the user locates and selects one of the NAS devices displayed by “clicking” on one of the appropriate default NAS name(s) displayed by the Workgroup directory in Windows Explorer, in order to access a NAS configuration file.

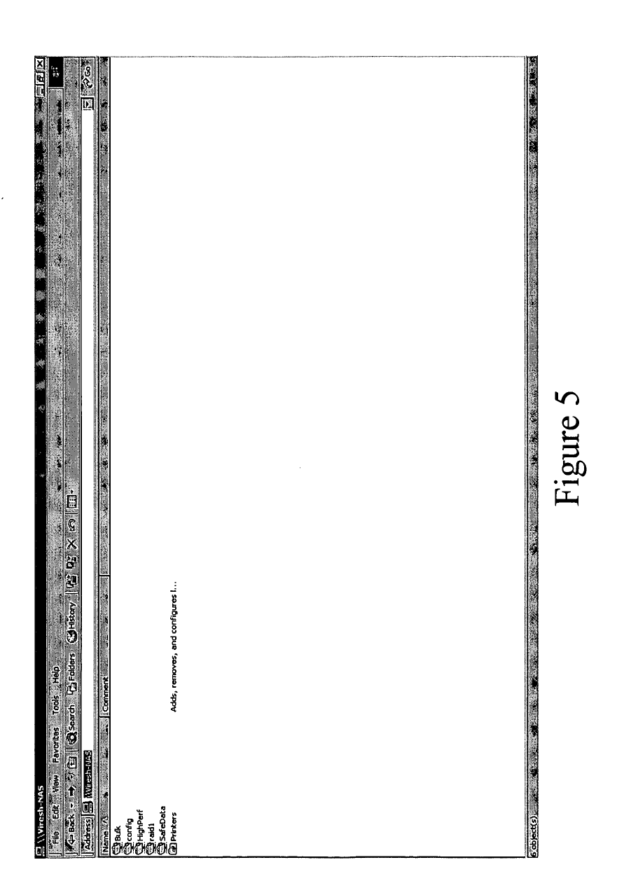

FIG. 5 illustrates a screen shot of Windows Explorer illustrating the directory contents of a data storage device or NAS having an exemplary default name, Viresh-NAS; the screen shot occurs after Viresh-NAS is selected from the Workgroup directory, in accordance with an embodiment of the invention. It is contemplated that a default name is preconfigured for each NAS at the time of manufacture. As illustrated in the embodiment of FIG. 5, Viresh-NAS contains a directory tree comprising the following directories: Bulk, config, HighPerf, raid 1, SafeData, and Printers. Referring back to FIG. 4, at step 416, the user locates the appropriate configuration file from the Viresh-NAS\config directory.

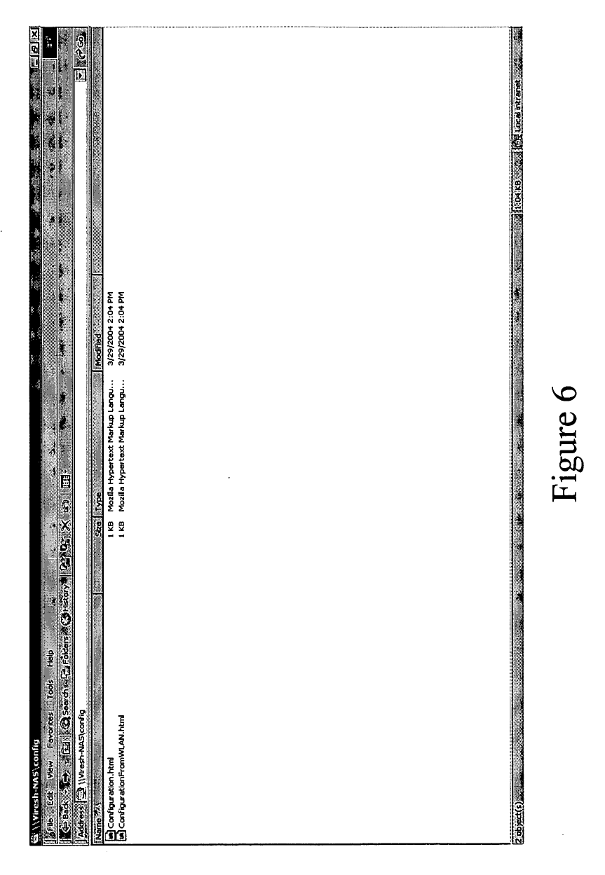

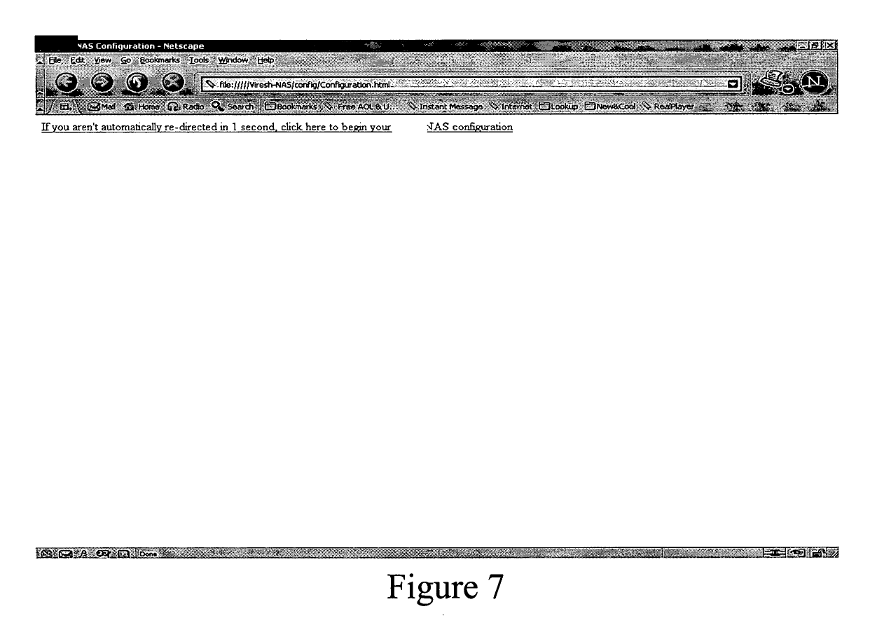

FIG. 6 illustrates a Windows Explorer screen shot of the Viresh-NAS\config directory, in accordance with an embodiment of the invention. As illustrated, the Viresh-NAS\config directory comprises two files, Configuration.html and ConfigurationFromWLAN.html. In this representative embodiment, the Configuration.html is associated with a local area network user interface setup while ConfigurationFromWLAN.html is associated with a wireless network user interface setup. Referring back to FIG. 4, at step 420, the appropriate configuration file is executed by “clicking” on the file. Execution of the configuration file allows an http server, residing in the data storage device or NAS to serve a browser residing in its client data processing device. The browser may comprise Netscape Navigator or Internet Explorer. In a representative embodiment, the browser notifies the user that the configuration file is being processed (executing the file) as illustrated in FIG. 7.

FIG. 7 illustrates a Netscape screen shot indicating that the configuration file is being processed, in accordance with an embodiment of the invention. Thereafter, Viresh-NAS generates a graphical user interface (after the pages are served by the http server) that allows the user to input various administrative parameters.

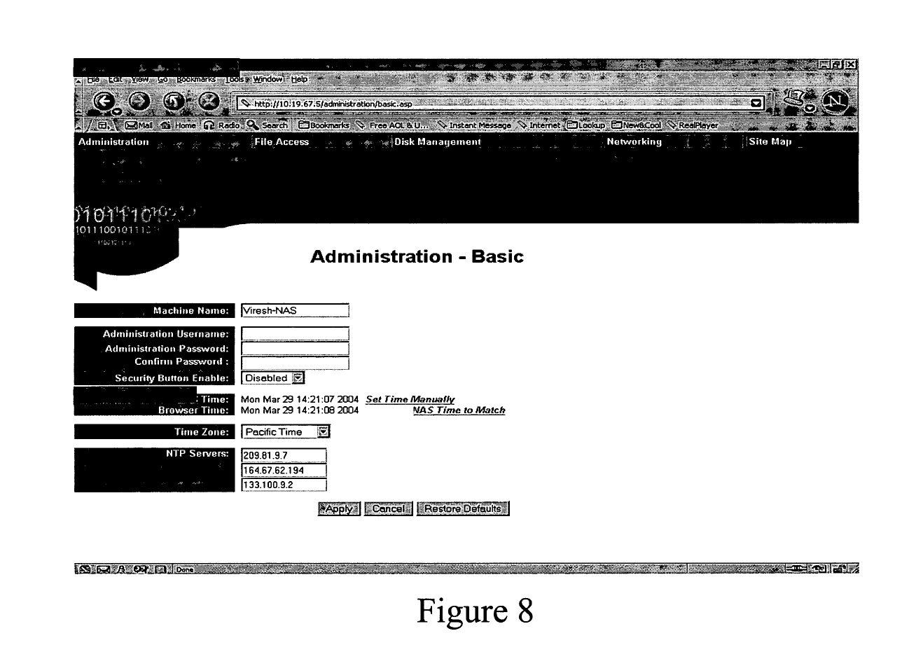

FIG. 8 illustrates a Netscape screen shot of an exemplary graphical user interface that allows a user to input one or more administrative parameters, in accordance with an embodiment of the invention. The one or more administrative parameters comprises a machine name for the data storage device or NAS, an administration username, an administration password, one or more alternate security actuators (such as a security button enabler), time, time zone, and network time server internet protocol addresses. Referring back to FIG. 4, at step 424, a user may input one or more authorized passwords in order to access one or more disk management graphical user interfaces. At step 428, a user accesses one or more desired disk management user interfaces. At step 432, a user configures or re-configures the one or more variables or parameters associated with the one or more hard disk drives using his point and click device. The point and click device may comprise an exemplary mouse. The point and click device may comprise any device capable of operating on one or more objects displayed by a display.

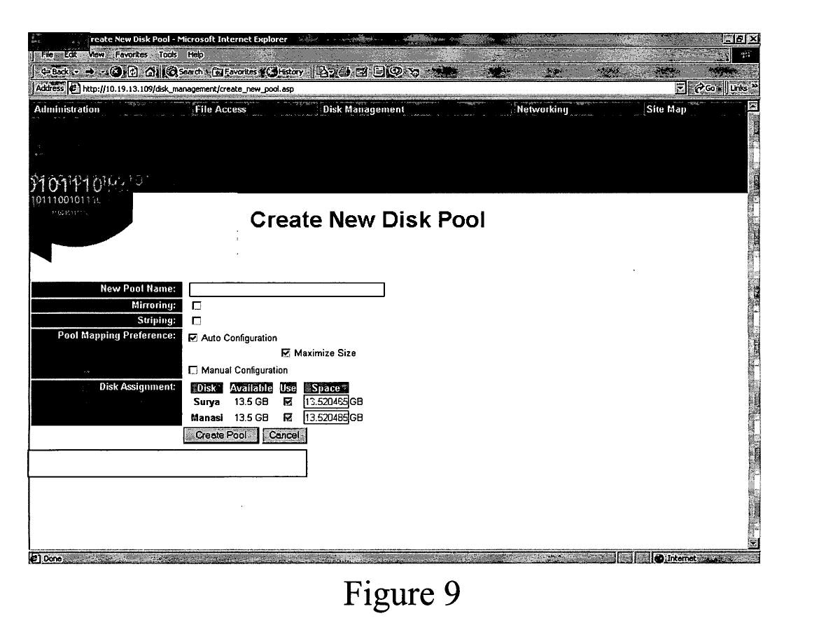

FIG. 9 displays a graphical user interface (GUI) used for displaying and configuring a data pool in accordance with an embodiment of the invention. A data pool may be defined by way of disk assignments made using two hard disk drives, for example. The GUI provides a field for inputting a data pool name. The GUI provides controls for configuring one or more parameters, such as mirroring or striping, for example. As shown, the two disk drives, named Surya and Manasi, each have an available capacity of 13.5 Gbytes. The exemplary GUI provides fields in which a user may adjust the contribution of each of the two disk drives towards the data pool.

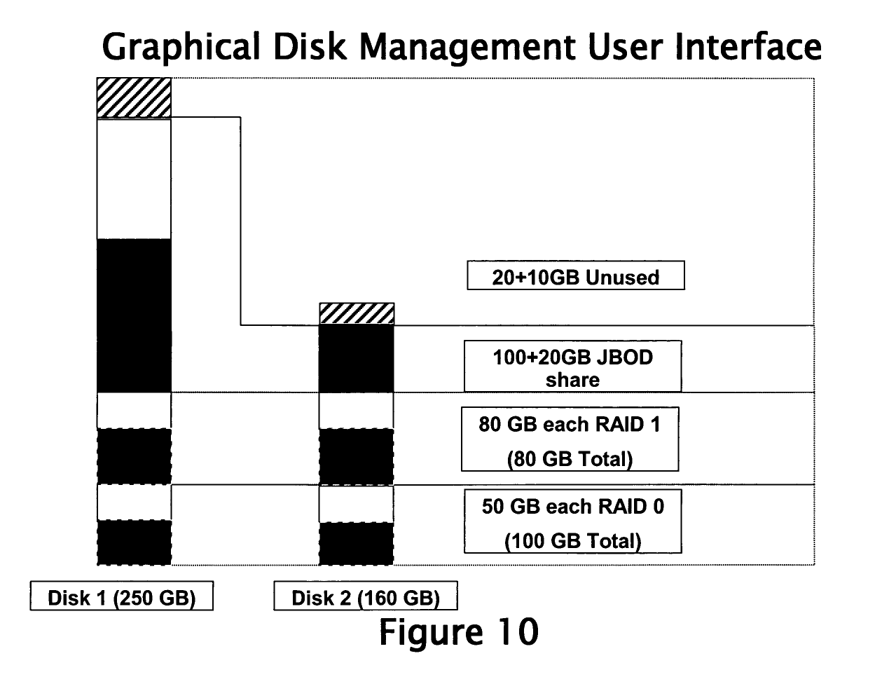

FIG. 10 illustrates a screen shot of a browser, such as Windows Explorer or Netscape Navigator, that provides a graphical user interface (GUI) in which a user may point, click, and drag one or more displayed objects or visual indicators, in order to vary one or more parameter values associated with the visual indicators, in accordance with an embodiment of the invention. In this fashion, the user may vary the size of one or more storage capacity parameters of a particular hard disk drive. For example, the user may vary the size of a hard disk drive's RAID 0 or RAID 1 parameter contribution, by way of resizing the one or more displayed objects or visual indicators. The user may perform the resizing by pointing a cursor over the object and dragging the border of the object to a desired size. In a representative embodiment, the GUI provides numerical values that reflect the storage contribution provided by a hard disk d rive.

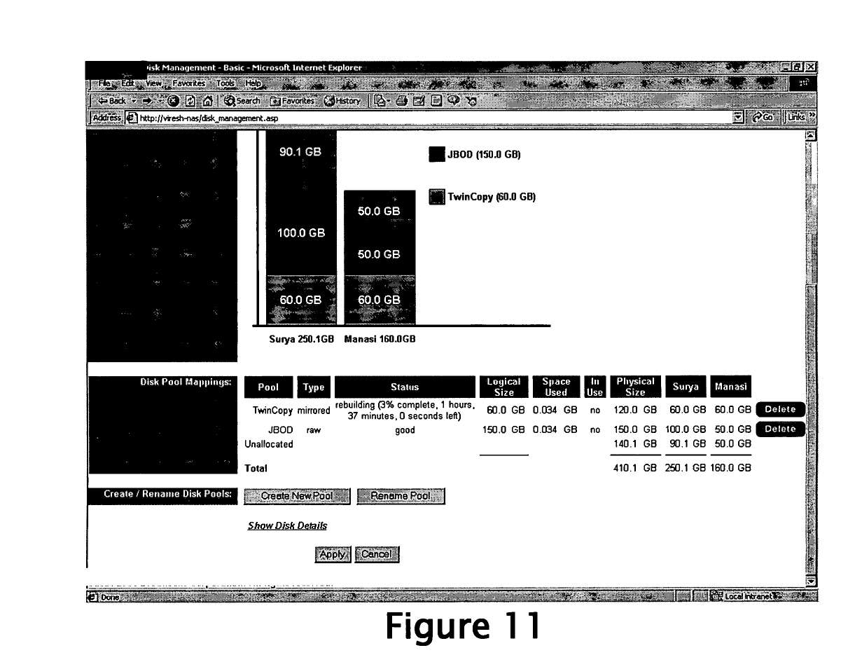

FIG. 11 illustrates a screen shot of a browser that provides an exemplary disk management user interface that allows a user to create, delete, or rename one or more data pools of the data storage device or NAS, in accordance with an embodiment of the invention. The browser may comprise Windows Explorer or Netscape Navigator, for example. The browser may provide a graphical user interface that illustrates the capacity of one or more data pools associated with the data storage device.

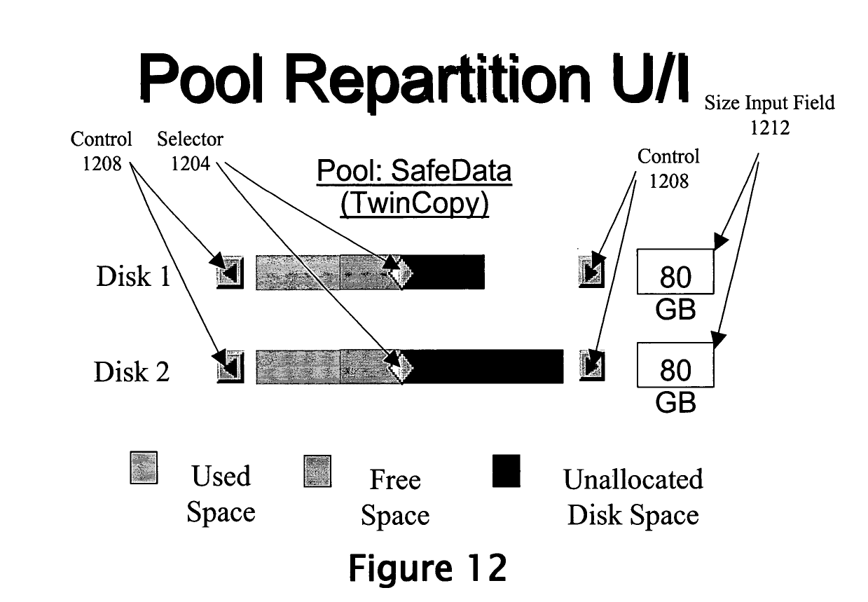

FIG. 12 illustrates a graphical user interface in which a user may re-partition, modify, or resize one or more data storage drives or hard disk drives by dragging a selector 1204 or adjusting one or more controls 1208 within the graphical user interface, in accordance with an embodiment of the invention. Portions of the one or more data storage drives or hard disk drives may be resized and allocated to a data pool. In this representative embodiment, portions of two disk drives, disk 1 and disk 2, are used to form the data pool named SafeData (TwinCopy). As illustrated, the portions allocated to form the data pool are determined by moving the selector 1204, which may be positioned or “dragged” using an exemplary mouse. Clicking on the controls 1208, with a mouse, one or more times may move the selector 1204 either left or right. Leftward movement decreases while a rightward movement increases the free space, for example. Repetitively clicking on a control may effectuate a rapid movement of the selector 1204. In this embodiment, the position of the selector 1204 determines the amount of free space available in either disk 1 or disk 2. FIG. 12 illustrates a graphical user interface implementing RAID1. As shown, the used and free space is mirrored and forms the pool named TwinCopy. As a result, the used and free space of Disk 1 is equivalent in size to the used and free space of Disk 2. When the user re-positions the selector 1204, the free space on both disks are decreased or increased commensurately. Alternatively, the size of the mirrored disks may be controlled by keyboard input using the size input field 1212. Keyboard input into the size input field 1212 may be used when a mouse or other similar device is unavailable to the user. The user may simply input the size (i.e., in gigabytes) of the mirrored pool into the size input field 1212.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A method of generating a data pool comprising:
receiving a name of said data pool, said receiving performed using a user interface; and
allocating storage capacities provided by one or more data storage drives for use by said data pool, said allocating performed using said user interface.

2. The method of claim 1 wherein said user interface provides an input field for receiving said name of said data pool.

3. The method of claim 1 wherein said user interface provides one or more input fields for receiving one or more values corresponding to said allocating said storage capacities provided by said one or more data storage drives for use by said data pool.

4. The method of claim 1 wherein said user interface comprises Microsoft Internet Explorer.

5. The method of claim 1 wherein said user interface comprises Netscape Navigator.

6. The method of claim 1 wherein said data storage drives comprise hard disk drives.

7. A method of modifying the size of a data pool, said data pool comprising storage capacity provided by one or more data storage drives, said method comprising operating a point and click device on a graphical user interface.

8. The method of claim 7 wherein said point and click device comprises a mouse.

9. The method of claim 7 wherein said data storage drives comprise hard disk drives.

10. A system for resizing storage capacity allocated for a data pool comprising:
a memory;
software instructions resident in said memory;
a processor capable of executing said software instructions; and
one or more data storage drives, said executing capable of generating a user interface for configuring said resizing of said storage capacity, said resizing performed by reallocating storage capacities provided by each of said one or more data storage drives for use by said data pool.

11. The system of claim 10 further comprising a point and click device.

12. The system of claim 11 wherein said point and click device is used to operate on one or more viewable objects provided by said user interface.

13. The system of claim 12 wherein said one or more viewable objects is used to configure said storage capacity provided by said one or more data storage drives.

14. The system of claim 10 wherein said one or more data storage drives is resident in a data storage device.

15. A system for generating a data pool comprising:
a memory;
software instructions resident in said memory;
a processor used to execute said software instructions; and
one or more data storage drives used for providing storage capacity for said data pool, wherein executing said software instructions generates a user interface, said user interface providing an input field for receiving a name of said data pool.

16. The system of claim 15 wherein said user interface provides one or more input fields for receiving one or more storage capacity values associated with said one or more data storage drives, said one or more storage capacity values used for allocating storage capacity for said data pool.

17. The system of claim 15 wherein said user interface provides two or more input fields for receiving two or more storage capacity values provided by said two or more data storage drives, said two or more storage capacity values used for allocating storage capacity for said data pool.

18. A method of modifying the size of a data pool, said data pool comprising storage capacity provided by two or more data storage drives, said method comprising operating a point and click device on a graphical user interface to input one or more data storage capacity values.
